(19) United States
(12) Patent Application Publication
(10) Pub. No.: US 2018/0278927 A1
(43) Pub. Date: Sep. 27, 2018

(54) FIELD DEVICE AND DEGRADATION DIAGNOSIS METHOD

(71) Applicant: AZBIL CORPORATION, Chiyoda-ku (JP)

(72) Inventor: Kouichiro Murata, Chiyoda-ku (JP)

(73) Assignee: AZBIL CORPORATION, Chiyoda-ku (JP)

(21) Appl. No.: 15/926,184

(22) Filed: Mar. 20, 2018

(30) Foreign Application Priority Data
Mar. 21, 2017 (JP) 2017-055034

(51) Int. Cl. H04N 17/00; G01N 21/93; G01J 1/16

(52) U.S. Cl. CPC H04N 17/004; G01J 2001/1615; G01J 1/16; G01N 21/93

(57) ABSTRACT

A diagnosis unit determines a first degradation degree of a display device on the basis of a measured illuminance calculated from an output of a photo sensor, compares the first degradation degree with a degradation threshold, and outputs a corresponding diagnosis when the first degradation degree reaches the degradation threshold.

### CROSS-REFERENCE TO RELATED APPLICATIONS

The present application is based on and claims priority to Japanese Application No. 2017-055034, filed Mar. 21, 2017, the entire contents of which are incorporated herein by reference.

### BACKGROUND

### 1. Field

The present disclosure relates to a degradation diagnosis technique for diagnosing degradation of a display device included in a field device.

### 2. Description of the Related Art

The functionality and the maintainability and operability of various kinds of field devices such as valve positioners and pressure transmitters used in process control at plants are enhanced and improved. With such enhancement and improvement, the field devices have recently come to include a display device such as a liquid crystal display (LCD) that displays various kinds of information.

Replacement timing of a component of a field device is sometimes displayed as one kind of information displayed on the display device of the field device. For example, according to Japanese Patent No. 342697, an amount of dust deposited on a nozzle and flapper mechanism provided in an electro-pneumatic positioner is estimated from a change in a nozzle back pressure. When the estimated amount exceeds a threshold, a message indicating the coming of maintenance timing for the nozzle and flapper mechanism is displayed on a display device. In this way, maintenance of the nozzle and flapper mechanism can be performed before the electro-pneumatic positioner malfunctions because of an increased amount of dust deposited on the nozzle and flapper mechanism.

Some models of field devices are operable for ten years or longer since their installation. However, field devices are sometimes installed in a crucial environment, such as a high-temperature, low-temperature, high-humidity, or direct-sunlight-exposed environment. The display device degrades fast due to sunlight in such a crucial environment. For example, at a plant located in a desert, a field device is installed in an environment in which a difference in temperature between daytime and nighttime is large and direct sunlight and reflection of sunlight are intense.

Thus, for example, if the display device is an LCD, following degradation is likely to occur. Specifically, the molecular structure of the liquid crystal is destroyed by ultraviolet rays and consequently the liquid crystal molecules do not operate expectedly, transparent electrodes are deteriorated by ultraviolet rays and consequently resistance changes, or the dot structure partly becomes inoperable. If such degradation occurs, the viewability decreases due to the occurrence of a blur resulting from decreased contrast, missing pixels, or liquid crystal leakage. Thus, a method for estimating a degradation degree of a display device and displaying a message indicating the coming of maintenance timing on the display device is conceivable.

However, since the influence received by the display device greatly varies depending on the environment in which the field device is installed, the life of the operating display device is not determined uniquely. In a crucial environment such as at a plant located in a desert as described before, the viewability is highly likely to decrease earlier than typical maintenance timing.

On the other hand, a method for regularly replacing a display device of each field device is also conceivable. However, since this method requires a maintenance person to visit the places at which field devices are installed at a plant to replace display devices regardless of the display devices have degradation, a large amount of maintenance cost is incurred. In particular, since field devices such as valve positioners having a sturdy structure to be robust against an explosion require a complex operation procedure to access a circuit unit including the display device, the load for the maintenance work further increases.

### SUMMARY

The present disclosure has been made to cope with such issues and aims to provide a degradation diagnosis technique that enables degradation of a display device of a field device to be appropriately diagnosed in accordance with an environment in which the field device installed.

To this end, a field device according to an aspect of the present disclosure is a field device including a display device that displays various kinds of information. The field device includes a photo sensor, and a diagnosis unit that determines a first degradation degree of the display device on the basis of a measured illuminance calculated from an output of the photo sensor and that compares the first degradation degree with a degradation threshold previously set for the display device. The diagnosis unit outputs a corresponding diagnosis when the first degradation degree reaches the degradation threshold.

In addition, in a configuration example of the field device according to the aspect of the present disclosure, the photo sensor may receive light illuminating the display device, and the diagnosis unit may compare the measured illuminance calculated from the output of the photo sensor with a previously set illuminance threshold to determine an occurrence state of first degradation caused in the display device in relation to illuminance of the light, totalize the first degradation degree of the display device in accordance with the determined occurrence state of the first degradation, compare the first degradation degree with the degradation threshold to diagnose degradation of the display device, and report a diagnosis regarding the display device in response to the first degradation degree reaching the degradation threshold.

In addition, in a configuration example of the field device according to the aspect of the present disclosure, the field device may further include a central processing unit that controls a target installation or measures a physical quantity, and the diagnosis unit may be implemented by the central processing unit.

In addition, in a configuration example of the field device according to the aspect of the present disclosure, the diagnosis unit may totalize the first degradation degree on the basis of a count result obtained by observing a clock of the central processing unit in a period for which the first degradation is caused.

In addition, in a configuration example of the field device according to the aspect of the present disclosure, the field device may further include a temperature sensor that detects a temperature near the display device, and the diagnosis unit may compare a measured temperature calculated from an output of the temperature sensor with a previously set temperature threshold to determine an occurrence state of second degradation caused in the display device in relation to temperature, totalize a second degradation degree of the display device in accordance with the determined occurrence state of the second degradation, calculate a total degradation degree by adding the first degradation degree and the second degradation degree using a predetermined ratio, and compare the total degradation degree with the degradation threshold to diagnose degradation of the display device.

In addition, in a configuration example of the field device according to the aspect of the present disclosure, the diagnosis unit may totalize a third degradation degree of the display device in accordance with an occurrence state of third degradation caused in the display device in relation to power supply, calculate a total degradation degree by adding the first degradation degree and the third degradation degree using a predetermined ratio, and compare the total degradation degree with the degradation threshold to diagnose degradation of the display device.

In addition, in a configuration example of the field device according to the aspect of the present disclosure, when totalizing the first degradation degree, the diagnosis unit may totalize, as the first degradation degree, at least one of a period for which the measured illuminance is greater than or equal to the illuminance threshold and the number of times the measured illuminance increases to be greater than or equal to the illuminance threshold from a value less than the illuminance threshold.

In addition, in a configuration example of the field device according to the aspect of the present disclosure when totalizing the second degradation degree, the diagnosis unit may totalize, as the second degradation degree, at least one of a period for which the measured temperature is greater than or equal to the temperature threshold and the number of times the measured temperature increases to be greater than or equal to the temperature threshold from a value less than the temperature threshold.

In addition, in a configuration example of the field device according to the aspect of the present disclosure when totalizing the third degradation degree, the diagnosis unit may totalize, as the third degradation degree, at least one of a period for which power is supplied to the field device or the display device and the number of times power supply to the field device or the display device is started.

In addition, a degradation diagnosis method according to an aspect of the present disclosure is a degradation diagnosis method used in a field device including a display device that displays various kinds of information, to diagnose degradation of the display device. The degradation diagnosis method includes a light-receiving step of receiving light with a photo sensor; and a diagnosis step, performed with a diagnosis unit, of determining a first degradation degree of the display device on the basis of a measured illuminance calculated from an output of the photo sensor, of comparing the first degradation degree with a degradation threshold previously set for the display device, and of outputting a corresponding diagnosis when the first degradation degree reaches the degradation threshold.

According to the aspects of the present disclosure when a first degradation degree exceeds a threshold, a corresponding diagnosis, specifically, information indicating that a display device of a field device has degraded to a certain degree is output as a diagnosis. Thus, degradation of the display device is appropriately diagnosed in accordance with an environment in which the field device is installed. Since the display device is replaced in accordance with the diagnosis output from the field device, inefficient maintenance work in which the display device of each field device is regularly replaced is no longer needed. Thus, cost for maintenance of the display devices can be reduced greatly.

### BRIEF DESCRIPTION OF THE DRAWINGS

FIG. 1 is a block diagram illustrating a configuration of a field device according to a first embodiment;

FIG. 2 is a front view of the field device according to the first embodiment;

FIG. 3 is a block diagram illustrating a detailed configuration of a diagnosis unit according to the first embodiment;

FIG. 4 is a flowchart illustrating a degradation diagnosis process according to the first embodiment;

FIG. 5 is a block diagram illustrating a configuration of a field device according to a second embodiment;

FIG. 6 is a front view of the field device according to the second embodiment;

FIG. 7 is a block diagram illustrating a detailed configuration of a diagnosis unit according to the second embodiment;

FIG. 8 is a flowchart illustrating a degradation diagnosis process according to the second embodiment;

FIG. 9 is a flowchart illustrating a degradation diagnosis process according to a third embodiment;

FIG. 10 is a flowchart illustrating a degradation diagnosis process according to a fourth embodiment;

FIG. 11 is a flowchart illustrating a degradation diagnosis process according to a fifth embodiment; and

FIG. 12 is a flowchart illustrating a degradation diagnosis process according to a sixth embodiment.

### DETAILED DESCRIPTION

Embodiments of the present disclosure will be described next with reference to the accompanying drawings.

### First Embodiment

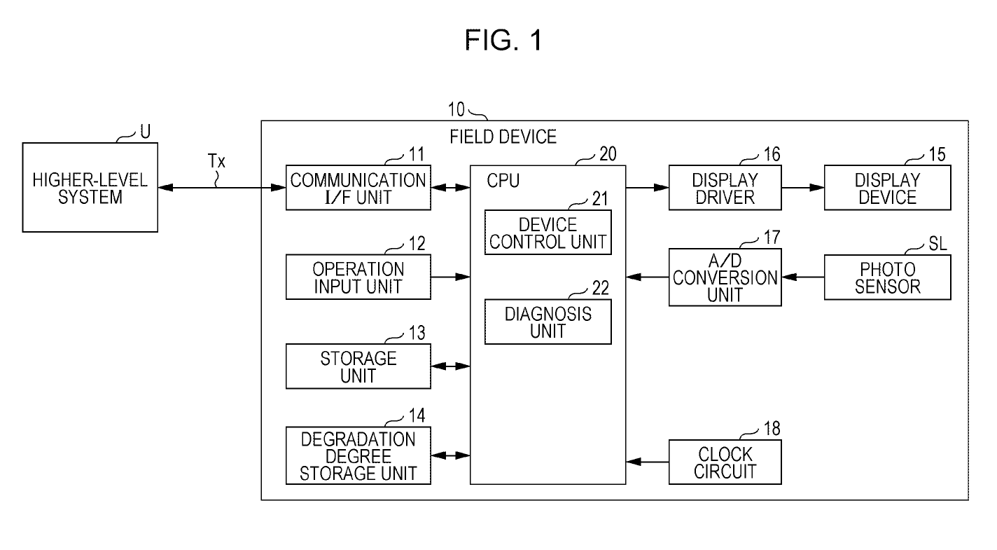

A field device 10 according to a first embodiment of the present disclosure will be described first with reference to FIG. 1. FIG. 1 is a block diagram illustrating a configuration of the field device 10 according to the first embodiment.

The field device 10 may be any of various kinds of field devices such as a valve positioner and a pressure transmitter used in process control at plants. The field device 10 has a function of controlling a target installation in accordance with an instruction given thereto from a higher-level system U connected to the field device 10 via a communication channel Tx and a function of measuring a physical quantity and reporting the measured physical quantity to the higher-level system U via the communication channel Tx.

The higher-level system U includes an information processing apparatus, such as a server apparatus, as a whole. The higher-level system U is a system that controls each installation placed at a facility such as a plant by using the field device 10 corresponding to the installation and that monitors and manages the operation state of each installation.

### Field Device

The field device 10 includes, as major functional units, a communication interface (I/F) unit 11, an operation input unit 12, a storage unit 13, a degradation degree storage unit 14, a display device 15, a display driver 16, a photo sensor SL, an analog-to-digital (A/D) conversion unit 17, a clock circuit 18, and a central processing unit (CPU) 20.

The communication I/F unit 11 has a function of performing data communication with the higher-level system U via the communication channel Tx.

The operation input unit 12 includes operation input devices, such as operation buttons, switches, or a touch panel. The operation input unit 12 has a function of detecting an operation performed by a maintenance person or the like and of outputting the detection result to the CPU 20.

The storage unit 13 includes a storage device, such as a semiconductor memory. The storage unit 13 has a function of storing various kinds of information to be processed and programs that are used in a processing operation performed by the CPU 20.

The degradation decree storage unit 14 includes a storage device, such as a non-volatile semiconductor memory or a semiconductor memory for which a battery is provided as a backup power supply. The degradation degree storage unit 14 has a function of storing degradation degrees that are used in a degradation diagnosis process performed on the display device 15 by the CPU 20 and that are obtained by totalizing the occurrence states of various kinds of degradations. Each degradation degree is an evaluation index indicating the degree of degradation of the display device 15.

The display device 15 is disposed at a display window 10B of the field device 10. The display device 15 has a function of visibly displaying various kinds of information by using a display element including electronic components, such as an LCD and light-emitting diodes (LEDs).

The display driver 16 has a function of driving the display device 15 in accordance with display data output from the CPU 20.

The photo sensor SL is disposed near the display device 15 in the display window 10B. The photo sensor SL is a sensor element that detects an illuminance of light illuminating the display device 15.

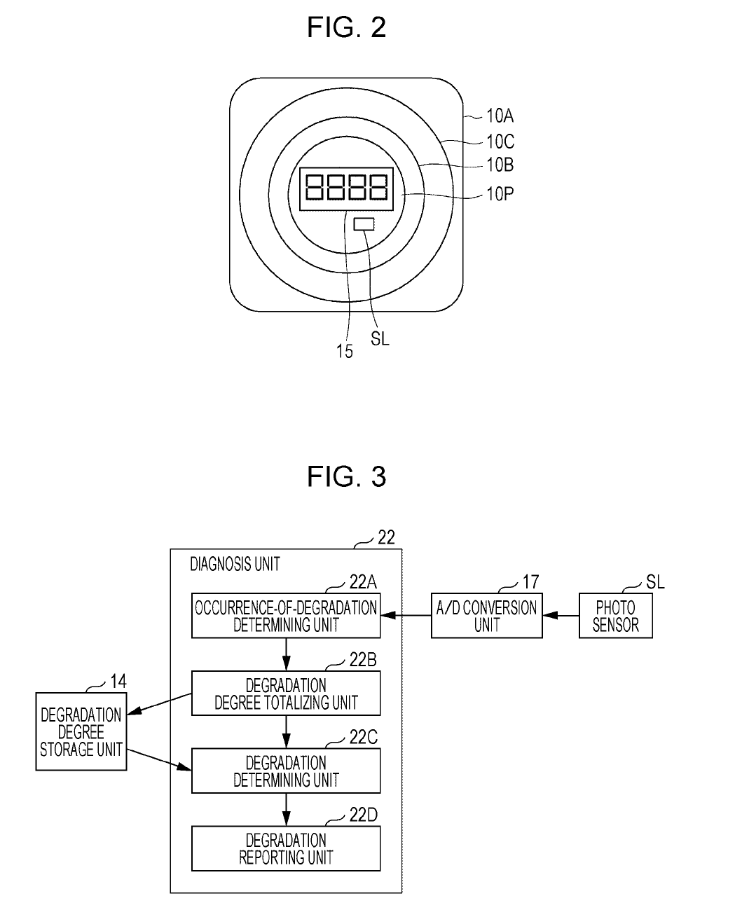

FIG. 2 is a schematic diagram of the field device 10 according to the first embodiment. The field device 10 has a main body 10A. The display window 10B covered with a transparent display cover 10C is formed at a portion of the main body 10A. Inside the main body 10A, an electronic circuit board 10P on which the display device 15, such as an LCD, is mounted is disposed. In addition, the photo sensor SL is mounted on the electronic circuit board 10P to be near the display device 15.

Referring back to FIG. 1, the AID conversion unit 17 has a function of performing A/D conversion on an analog signal output from the photo sensor SL and of outputting the resultant digital signal to the CPU 20.

The clock circuit 18 is a circuit that generates a clock signal having a predetermined frequency and that supplies the clock signal to the CPU 20.

The CPU 20 includes a microprocessor that operates in accordance with the clock signal supplied thereto from the clock circuit 18. The CPU 20 has a function of implementing various processing units, together with a program stored in the storage unit 13. The CPU 20 includes a device control unit 21 and a diagnosis unit 22 as major processing units implemented thereby.

The device control unit 21 has a function of controlling a target installation in accordance with an instruction given thereto from the higher-level system U connected to the field device 10 via the communication channel Tx and a function of measuring a physical quantity and reporting the measured physical quantity to the higher-level system U via the communication channel Tx.

The diagnosis unit 22 has a function of comparing a measured illuminance L calculated from an output of the photo sensor SL with an illuminance threshold Lth to determine the occurrence state of first degradation caused in the display device 15 in relation to illuminance of light. The diagnosis unit 22 also has a function of totalizing a first degradation degree Na of the display device 15 in accordance with the determined occurrence state of the first degradation. The diagnosis unit 22 further has a function of comparing the first degradation degree Na with a degradation threshold Nth previously set for the display device 15 to diagnose degradation of the display device 15.

FIG. 3 is a block diagram illustrating a detailed configuration of the diagnosis unit 22 according to the first embodiment. The diagnosis unit 22 includes an occurrence-of-degradation determining unit 22A, a degradation degree totalizing unit 225, a degradation determining unit 22C, and a degradation reporting unit 22D as major processing units.

The occurrence-of-degradation determining unit 22A has a function of calculating the measured illuminance L from an output acquired from the photo sensor SL via the A/D conversion unit 17. The occurrence-of-degradation determining unit 22A also has a function of comparing the calculated measured illuminance L with a previously set illuminance threshold Lth (30000 1×, for example) to determine whether the first degradation, which results from illumination of the display device 15, is caused.

The degradation degree totalizing unit 22B has a function of observing a clock used by the CPU 20 in a period for which the first degradation determined by the occurrence-of-degradation determining unit 22A is caused. The degradation degree totalizing unit 22B also has a function of incrementing the first degradation degree Na by 1 (+1) every time the degradation degree totalizing unit 22B observes the clock a predetermined number of times. The first degradation degree Na is stored in the degradation degree storage unit 14 and is totalized since the use of the display device 15 has been started. Note that the clock that is observed may be the clock signal supplied from the clock circuit 18 or may be an internal clock that is generated by performing frequency division on the basis of the clock signal at the CPU 20.

The degradation determining unit 22C has a function of comparing the first degradation degree Na stored in the degradation degree storage unit 14 with the previously set degradation threshold Nth and of determining degradation of the display device 15 upon the first degradation degree Na reaching the degradation threshold Nth. Note that the degradation determining unit 22C is able to determine various degradation degrees, such as a life reaching level at which the display device 15 is no longer able to correctly display information and a serious degradation level indicating that the life of the display device 15 will be reached soon, by appropriately setting the degradation threshold Nth.

The degradation reporting unit 22D has a function of displaying a diagnosis regarding degradation of the display device 15 on the display device 15 in accordance with the degradation determined by the degradation determining unit 22C. The degradation reporting unit 22D also has a function of reporting the diagnosis regarding the degradation of the display device 15 to the higher-level system U from the communication I/F unit 11 via the communication channel Tx. The diagnosis regarding degradation may be information indicating that the first degradation degree Na has reached the degradation threshold Nth or may be specific information according to the degradation threshold Nth, such as a warning indicating a life-reached state or a serious degradation state, for example.

### Operation According to First Embodiment

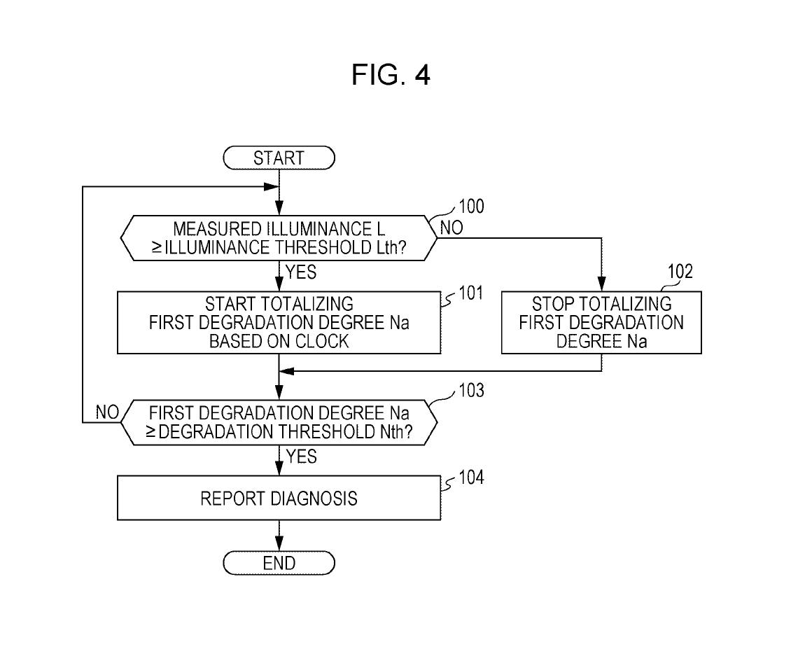

An operation of the field device 10 according to the first embodiment will be described next with reference to FIG. 4. FIG. 4 is a flowchart illustrating a degradation diagnosis process according to the first embodiment.

The CPU 20 of the field device 10 performs the degradation diagnosis process illustrated in FIG. 4 after power-on or a reset operation.

The occurrence-of-degradation determining unit 22A of the diagnosis unit 22 calculates the measured illuminance L from the output of the photo sensor SL acquired via the A/D conversion unit 17. The occurrence-of-degradation determining unit 22A compares the calculated measured illuminance L with the previously set illuminance threshold Lth to determine whether the first degradation, which results from illumination of the display device 15, is caused (step 100).

If the measured illuminance L is greater than or equal to the illuminance threshold Lth (L≥Lth) (YES in step 100), the degradation degree totalizing unit 22B determines that the first degradation is caused and starts totalizing the first degradation degree Na based on the clock used by the CPU 20 (step 101). Specifically, the degradation degree totalizing unit 22B starts observing the clock and increments by 1 (+1), every time the clock is observed a predetermined number of times, the first degradation degree Na that is stored in the degradation degree storage unit 14 and is totalized after the use of the display device 15 has been started.

On the other hand, if the measured illuminance L is less than the illuminance threshold Lth (L<Lth) (NO in step 100), the degradation degree totalizing unit 22B determines that the first degradation is not caused and stops totalizing the first degradation degree Na (step 102).

Then, the degradation determining unit 22C compares the first degradation degree Na stored in the degradation degree storage unit 14 with the previously set degradation threshold Nth (step 103). If the first degradation degree Na has not reached the degradation threshold Nth (Na<Nth) (NO in step 103), the process returns to step 100. In this case, since illuminance of light illuminating the display device 15 does not change frequently in general, the processing of step 100 may be performed at a predetermined interval of 30 minutes or 1 hour, for example. This configuration can greatly reduce the processing load of the CPU 20.

On the other hand, if the first degradation degree Na has reached the degradation threshold Nth (Na Nth) (YES in step 103), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step 104). Then, the degradation diagnosis process ends.

### Advantageous Effects of First Embodiment

As described above, in the first embodiment, the diagnosis unit 22 determines the first degradation degree Na of the display device 15 on the basis of the measured illuminance L calculated from the output of the photo sensor SL and compares the first degradation degree Na with the degradation threshold Nth. If the first degradation degree Na reaches the degradation threshold Nth, the diagnosis unit 22 outputs a corresponding diagnosis.

With such a configuration, upon the first degradation degree Na reaching the degradation threshold Nth, a corresponding diagnosis, specifically, information indicating that the display device 15 has degraded to some degree is output as a diagnosis. Thus, degradation of the display device 15 can be diagnosed in accordance with an environment in which the field device 10 is installed.

Therefore, since the work for replacing the display device 15 is performed in accordance with the diagnosis output from each field device 10, inefficient maintenance work for regularly replacing the display device 15 of each field device 10 is no longer needed. Consequently, cost for the maintenance of the display devices 15 can be greatly reduced. In addition, by appropriately setting the degradation threshold Nth, the fact that the display device 15 has degraded to a certain degree can be diagnosed before the life of the display device 15 is reached, as well as expiration of the life of the display device 15. Thus, the display device 15 can be replaced in time for or before expiration of the life.

In addition, in the first embodiment, the measured illuminance L calculated from the output of the photo sensor SL is compared with the illuminance threshold Lth. The first degradation degree Na of the display device 15 is totalized in accordance with the determined occurrence state of the first degradation. The first degradation degree Na is then compared with the degradation threshold Nth previously set for the display device 15, to diagnose degradation of the display device 15. Then, a diagnosis for the display device 15 may be reported upon the first degradation degree Na reaching the degradation threshold Nth.

With such a configuration, the degradation degree of the display device 15 is adaptively totalized in accordance with the illuminance of light illuminating the display device 15 and the illumination state. Thus, the life of the display device 15 can be appropriately diagnosed individually for each field device 10 installed in a different environment.

Thus, according to the first embodiment, since the work for replacing the display device 15 is performed in accordance with the diagnosis reported from each field device 10, inefficient maintenance work for regularly replacing the display device 15 of each field device 10 is no longer needed. Consequently, cost for maintenance of the display devices 15 can be greatly reduced.

In the first embodiment, degradation of the display device 15 may be diagnosed by using the CPU 20 that is included in the field device 10 and that controls a target installation or measures a physical quantity. More specifically, the first degradation degree Na may be determined by totalizing the count result obtained by counting the clock of the CPU 20 in a period for which the first degradation is caused. With such a configuration, the number of components, such as the photo sensor SL and the degradation degree storage unit 14, to be added to the field device 10 to implement the function of diagnosing degradation of the display device 15 can be minimized and the function of diagnosing the degradation can be implemented at an extremely low cost. In addition, the function of diagnosing the degradation can be implemented by using the existing CPU 20 while minimizing an increase in the processing load applied to the CPU 20.

### Second Embodiment

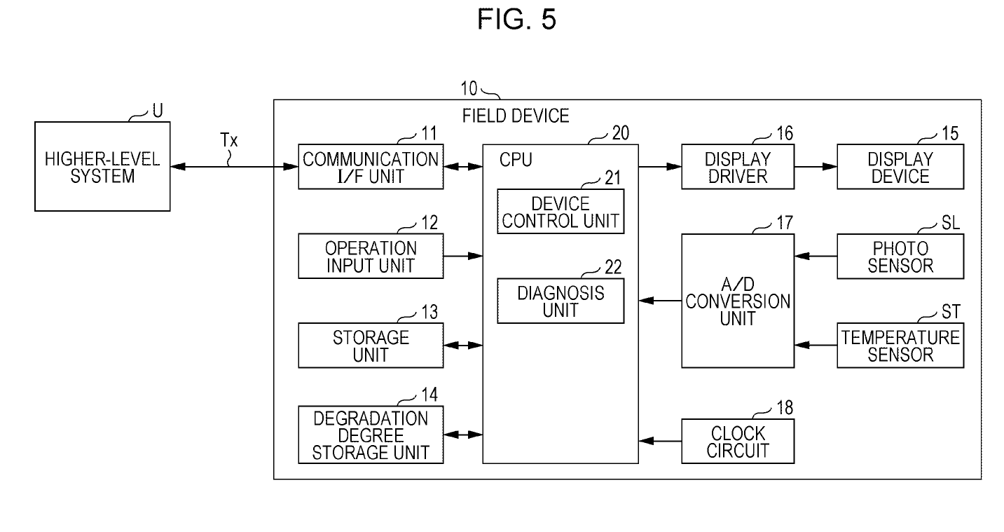

A field device 10 according to a second embodiment of the present disclosure will be described next with reference to FIG. 5. FIG. 5 is a block diagram illustrating a configuration of the field device 10 according to the second embodiment.

In the second embodiment, a temperature sensor ST is further added to the first embodiment. In the second embodiment, a description will be given of the case where degradation of the display device 15 is diagnosed by taking into account degradation related to temperature as well as degradation related to illuminance.

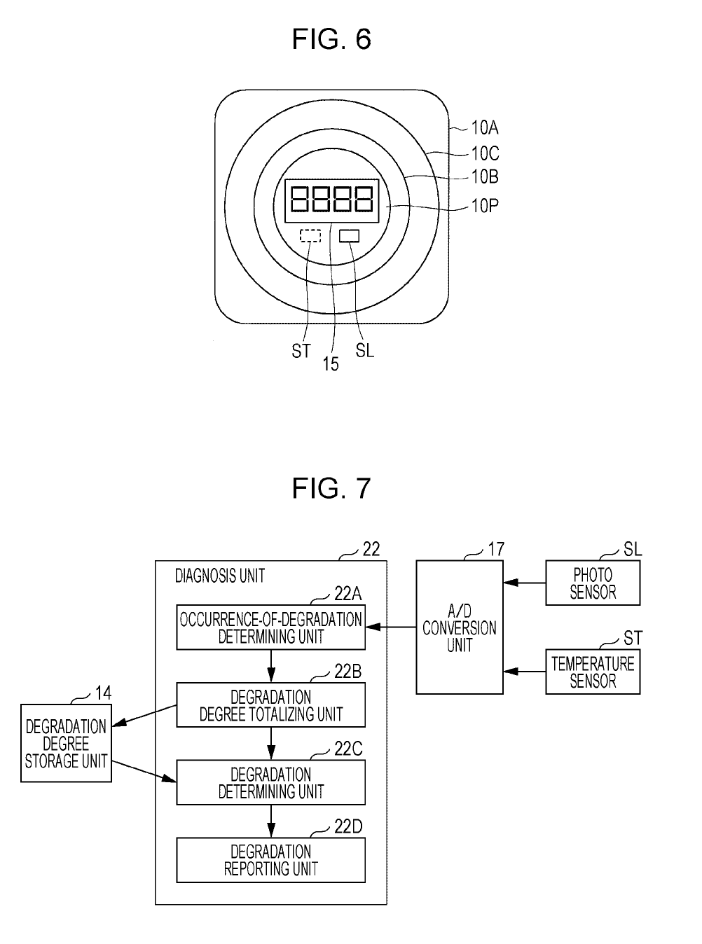

FIG. 6 is a front view of the field device 10 according to the second embodiment. In contrast to FIG. 2, the temperature sensor ST is disposed on the back surface of the electronic circuit board 10P to be near the display device 15.

Referring back to FIG. 5, the A/D conversion unit 17 has a function of performing A/D conversion on analog signals output from the photo sensor SL and the temperature sensor ST and of outputting the resultant digital signals the CPU 20.

The diagnosis unit 22 has a function of comparing a measured illuminance L calculated from an output of the photo sensor SL with an illuminance threshold Lth to determine an occurrence state of first degradation caused in the display device 15 in relation to illuminance of light. The diagnosis unit 22 also has a function of totalizing a first degradation degree Na of the display device 15 in accordance with the determined occurrence state of the first degradation. The diagnosis unit 22 has a function of comparing a measured temperature T calculated from an output of the temperature sensor ST with a temperature threshold Tth to determine an occurrence state of second degradation caused in the display device 15 in relation to temperature. The diagnosis unit 22 also has a function of totalizing a second degradation degree Nb of the display device 15 in accordance with the determined occurrence state of the second degradation. The diagnosis unit 22 further has a function of determining a total degradation degree N by adding the first degradation degree Na and the second degradation degree Nb by using a predetermined ratio of Wa:Wb (where Wa denotes a first weight for the first degradation degree Na and Wb denotes a second weight for the second degradation degree Nb) and of comparing the total degradation degree N with a degradation threshold Nth previously set for the display device 15 to diagnose degradation of the display device 15.

FIG. 7 is a block diagram illustrating a detailed configuration of the diagnosis unit 22 according to the second embodiment.

The occurrence-of-degradation determining unit 22A has a function of calculating the measured illuminance L from the output of the photo sensor SL acquired via the A/D conversion unit 17, and a function of comparing the calculated measured illuminance L with the previously set illuminance threshold Lth to determine whether the first degradation due to illumination of the display device 15 is caused. The occurrence-of-degradation determining unit 22A also has a function of calculating the measured temperature T from the output of the temperature sensor ST acquired via the A/D conversion unit 17 and a function of comparing the calculated measured temperature T with the previously set temperature threshold Tth (40° C., for example) to determine whether the second degradation due to temperature is caused in the display device 15.

The degradation degree totalizing unit 22B has a function of observing a clock used by the CPU 20 in a period for which the first degradation determined by the occurrence-of-degradation determining unit 22A is caused and a function of incrementing by 1 (+1), every time this clock is observed a predetermined number of times, the first degradation degree Na that is stored in the degradation degree storage unit 14 and that is totalized after the use of the display device 15 has been started. The degradation degree totalizing unit 22B also has a function of observing the clock used by the CPU 20 in a period for which the second degradation determined by the occurrence-of-degradation determining unit 22A is caused and a function of incrementing by 1 (+1), every time this clock is observed a predetermined number of times, the second degradation degree Nb that is stored in the degradation degree storage unit 14 and that is totalized after the use of the display device 15 has been started. Note that the clock that is observed may be the clock signal supplied from the clock circuit 18 or may be an internal clock that is generated by performing frequency division on the basis of the clock signal at the CPU 20.

The degradation determining unit 22C has a function of determining the total degradation degree N by adding the first degradation degree Na and the second degradation degree Nb stored in the degradation degree storage unit 14 by using the predetermined ratio of Wa:Wb, of comparing the total degradation degree N with the degradation threshold Nth previously set for the display device 15, and of determining degradation of the display device 15 upon the total degradation degree N reaching the degradation threshold Nth. The predetermined ratio Wa:Wb is equivalent to a ratio between the degree of illuminance-related degradation of the display device 15 and the degree of temperature-related degradation of the display device 15. For example, a ratio experientially obtained in advance, such as 10:1, may be used.

The degradation reporting unit 22D has a function of displaying a diagnosis regarding the degradation of the display device 15 on the display device 15 in accordance with the degradation determined by the degradation determining unit 22C and a function of reporting the diagnosis regarding the degradation of the display device 15 to the higher-level system U from the communication I/F unit 11 via the communication channel Tx.

### Operation According to Second Embodiment

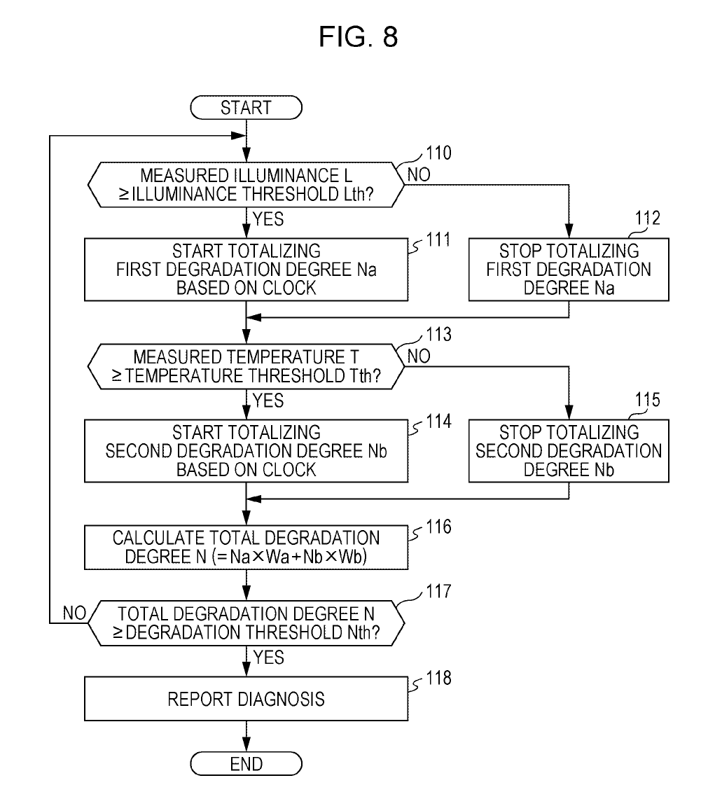

An operation of the field device 10 according to the second embodiment will be described next with reference to FIG. 8. FIG. 8 is a flowchart illustrating a degradation diagnosis process according to the second embodiment.

The CPU 20 of the field device 10 performs the degradation diagnosis process illustrated in FIG. 8 after power-on or a reset operation.

First, the occurrence-of-degradation determining unit 22A of the diagnosis unit 22 calculates the measured illuminance L from the output of the photo sensor SL acquired via the A/D conversion unit 17 and compares the calculated measured illuminance L with the previously set illuminance threshold Lth to determine whether the first degradation due to illumination of the display device 15 is caused (step 110).

If the measured illuminance L is greater than or equal to the illuminance threshold Lth (L≥Lth) (YES in step 110), the degradation degree totalizing unit 22B determines that the first degradation is caused and starts totalizing the first degradation degree Na based on the clock of the CPU 20 (step 111). Specifically, the degradation degree totalizing unit 22B starts observing the clock and increments by 1 (+1), every time the clock is observed a predetermined number of times, the first degradation degree Na that is stored in the degradation degree storage unit 14 and that is totalized after the use of the display device 15 has been started.

On the other hand, if the measured illuminance L is less than the illuminance threshold Lth (L<Lth) (NO in step 110), the degradation degree totalizing unit 22B determines that the first degradation is not caused and stops totalizing the first degradation degree Na (step 112).

The occurrence-of-degradation determining unit 22A also calculates the measured temperature T from the output of the temperature sensor ST acquired via the A/D conversion unit 17 and compares the calculated measured temperature T with the previously set temperature threshold Tth to determine whether the second degradation due to temperature is caused in the display device 15 (step 113).

If the measured temperature T is greater than or equal to the temperature threshold Tth (T≥Tth) (YES in step 113), the degradation degree totalizing unit 22B determines that the second degradation is caused and starts totalizing the second degradation degree Nb based on the clock of the CPU 20 (step 114). Specifically, the degradation degree totalizing unit 22B starts observing the clock and increments by 1 (+1), every time the clock is observed a predetermined number of times, the second degradation degree Nb that is stored in the degradation degree storage unit 14 and that is totalized after the use of the display device 15 has been started.

On the other hand, if the measured temperature T is less than the temperature threshold Tth (T<Tth) (NO in step 113), the degradation degree totalizing unit 22B determines that the second degradation is not caused and stops totalizing the second degradation degree Nb (step 115).

Then, the degradation determining unit 22C calculates the total degradation degree N (=Na×Wa+Nb×Wb) by adding the first degradation degree Na and the second degradation degree Nb stored in the degradation degree storage unit 14 by using the predetermined ratio of Wa:Wb (step 116). The degradation determining unit 22C compares the total degradation degree N with the degradation threshold Nth previously set for the display device 15 (step 117).

If the total degradation degree N has not reached the degradation threshold Nth (N<Nth) (NO in step 117), the process returns to step 110. In this case, since the illuminance of light illuminating the display device 15 and the temperature do not change frequently in general, the processing of step 110 may be performed at a predetermined interval of 30 minutes or 1 hour, for example. This configuration can greatly reduce the processing load of the CPU 20.

On the other hand, if the total degradation degree N has reached the degradation threshold Nth (N≥Nth) (YES in step 117), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step 118). Then, the degradation diagnosis process ends.

### Advantageous Effects of Second Embodiment

As described above, in the second embodiment, the diagnosis unit 22 compares the measured temperature T calculated from the output of the temperature sensor ST with the temperature threshold Tth, totalizes the second degradation degree Nb of the display device 15 in accordance with the determined occurrence state of the second degradation, calculates the total degradation degree N by adding the first degradation degree Na and the second degradation degree Nb by using the predetermined ratio, and compares the total degradation degree N with the degradation threshold Nth to diagnose degradation of the display device 15.

With such a configuration, not only the first degradation due to light illuminating the display device 15 but also the second degradation due to temperature can be taken into account. Consequently, the life of the display device 15 can be diagnosed more accurately.

### Third Embodiment

A field device 10 according to a third embodiment of the present disclosure will be described next.

In the third embodiment, a case will be described where degradation of the display device 15 is diagnosed by taking into account not only illuminance-related degradation but also power-supply-related degradation, in contrast to the first embodiment. Since a block diagram of the field device 10 according to the third embodiment is the same as that illustrated in FIG. 1, a detailed description thereof is omitted here.

The diagnosis unit 22 has a function of comparing a measured illuminance L calculated from an output of the photo sensor SL with an illuminance threshold Lth to determine an occurrence state of first degradation related to illuminance of light illuminating the display device 15, and a function of totalizing a first degradation degree of the display device 15 in accordance with the determined occurrence state of the first degradation. The diagnosis unit 22 also has a function of totalizing a third degradation degree Nc of the display device 15 in accordance with an occurrence state of third degradation that is caused because of power supply to the display device 15. The diagnosis unit 22 further has a function of determining a total degradation degree N by adding the first degradation degree Na and the third degradation degree Nc by using a predetermined ratio of Wa:Wc (where Na denotes a first weight for the first degradation degree Na and We denotes a third weight for the third degradation degree Nc) and of comparing the total degradation degree N with a degradation threshold Nth previously set for the display device 15 to diagnose degradation of the display device 15.

The occurrence-of-degradation determining unit 22A has a function of calculating the measured illuminance L from the output of the photo sensor SL acquired via the A/D conversion unit 17 and a function of comparing the calculated measured illuminance L with the previously set illuminance threshold Lth to determine whether the first degradation due to illumination of the display device 15 is caused. The occurrence-of-degradation determining unit 22A also has a function of determining whether the third degradation due to power supply to the display device 15 is caused in accordance with control information that is held by the CPU 20 and that indicates that power is supplied to the field device 10 or the display device 15.

In this case, for example, if the CPU 20 separately controls power supply to the display device 15 by using the display driver 16, a period for which power is supplied to the display device 15 needs to be determined. However, if power is supplied to the display device 15 all the time, it may be determined that the third degradation is caused for a period for which power supplied to the field device 10, that is, for the entire period for which the degradation diagnosis process is performed.

The degradation degree totalizing unit 22B has a function of observing a clock used by the CPU 20 in a period for the first degradation determined by the occurrence-of-degradation determining unit 22A is caused and a function of incrementing by 1 (+1), every time this clock is observed a predetermined number of times, the first degradation degree Na that is stored in the degradation degree storage unit 14 and that is totalized after the use of the display device 15 has been started. The degradation degree totalizing unit 22B also has a function of observing the clock used by the CPU 20 in a period for which the third degradation determined by the occurrence-of-degradation determining unit 22A is caused and a function of incrementing by 1 (+1), every time this clock is observed a predetermined number of times, the third degradation degree Nc that is stored in the degradation degree storage unit 14 and that is totalized after the use of the display device 15 has been started. Note that the clock that is observed may be the clock signal supplied from the clock circuit 18 or may be an internal clock that is generated by performing frequency division on the basis of the clock signal at the CPU 20.

The degradation determining unit 22C has a function of calculating the total degradation degree N by adding the first degradation degree Na and the third degradation degree Nc stored in the degradation degree storage unit 14 by using the predetermined ratio of Wa:W , of comparing the total degradation degree N with the degradation threshold Nth previously set for the display device 15, and of determining degradation of the display device 15 upon the total degradation degree N reaching the degradation threshold Nth. The ratio of Wa:Wc corresponds to a ratio between the degree of illuminance-related degradation of the display device 15 and the degree of power-supply-related degradation of the display device 15. For example, a ratio experientially obtained in advance, such as 10:1, may be used.

The degradation reporting unit 22D has a function of displaying a diagnosis regarding the degradation of the display device 15 on the display device 15 in accordance with the degradation determined by the degradation determining unit 22C and a function of reporting the diagnosis regarding the degradation of the display device 15 to the higher-level system U from the communication I/F unit 11 via the communication channel Tx.

### Operation According to Third Embodiment

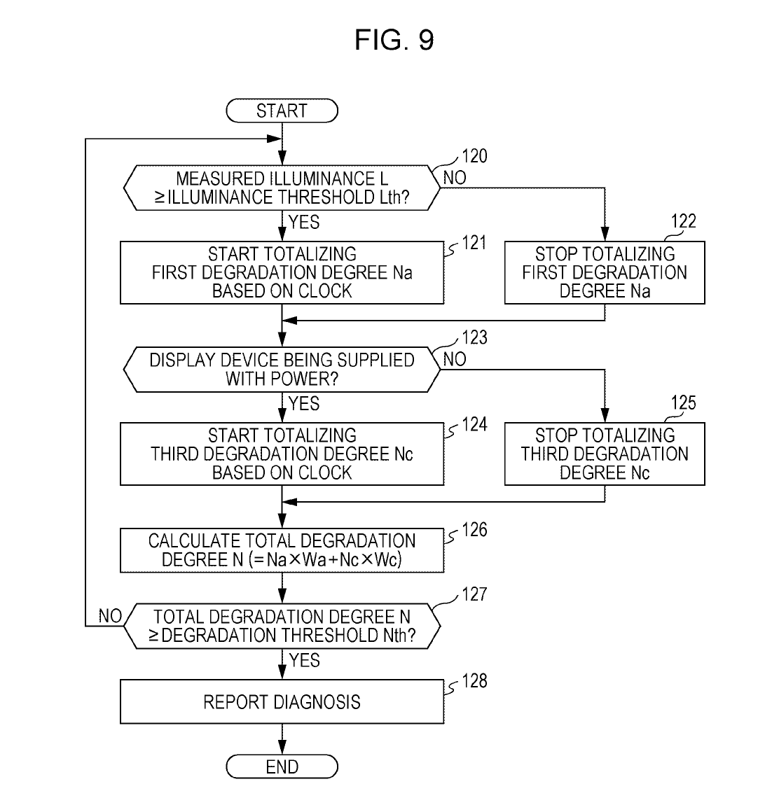

An operation of the field device 10 according to the third embodiment will be described next with reference to FIG. 9. FIG. 9 is a flowchart illustrating a degradation diagnosis process according to the third embodiment.

The CPU 20 of the field device 10 performs the degradation diagnosis process illustrated in FIG. 9 after power-on or a reset operation.

First, the occurrence-of-degradation determining unit 22A of the diagnosis unit 22 calculates the measured illuminance L from the output of the photo sensor SL acquired via the A/D conversion unit 17 and compares the calculated measured illuminance L with the previously set illuminance threshold Lth to determine whether the first degradation due to illumination of the display device 15 is caused (step 120).

If the measured illuminance L is greater than or equal to the illuminance threshold Lth (L≥Lth) (YES in step 120), the degradation degree totalizing unit 22B determines that the first degradation is caused and starts totalizing the first degradation degree Na based on the clock of the CPU 20 (step 121). Specifically, the degradation degree totalizing unit 22B starts observing the clock and increments by 1 (+1), every time the clock is observed a predetermined number of times, the first degradation degree Na that is stored in the degradation degree storage unit 14 and that is totalized after the use of the display device 15 has been started.

If the measured illuminance L is less than the illuminance threshold Lth (L<Lth) (NO in step 120), the degradation degree totalizing unit 22B determines that the first degradation is not caused and stops totalizing the first degradation degree Na (step 122).

In addition, the occurrence-of-degradation determining unit 22A checks whether power is supplied to the display device 15 on the basis of the control information of the CPU 20 to determine whether the third degradation due to power supply to the display device 15 is caused (step 123).

If power is supplied to the display device 15 (YES in step 123), the degradation degree totalizing unit 22B determines that the third degradation is caused and starts totalizing the third degradation degree Nc based on the clock of the CPU 20 (step 124). Specifically, the degradation degree totalizing unit 22B starts observing the clock and increments by 1 (+1), every time the clock is observed a predetermined number of times, the third degradation degree Nc that is stored in the degradation degree storage unit 14 and that is totalized after the use of the display device 15 has been started.

On the other hand, if power is not supplied to the display device 15 (NO in step 123), the degradation degree totalizing unit 22B determines that the third degradation is not caused and stops totalizing the third degradation degree Nc (step 125).

Then, the degradation determining unit 22C calculates the total degradation degree N (=Na×Na+Nc×Nc) by adding the first degradation degree Na and the third degradation degree Nc stored in the degradation degree storage unit 14 by using the predetermined ratio of Wa:Wc (step 126) and compares the calculated total degradation degree N with the degradation threshold Nth previously set for the display device 15 (step 127).

If the total degradation degree N has not reached the degradation threshold Nth (N<Nth) (NO in step 127), the process returns to step 120. In this case, since the illuminance of light illuminating to the display device 15 does not change frequently in general, the processing of step 120 may be performed at a predetermined interval of 30 minutes or 1 hour, for example, if power supply to the display device 15 is synchronized with power supply to the field device 10. This configuration can greatly reduce the processing load of the CPU 20. In addition, the processing of step 120 may be performed when the power supply state of the display device 15 changes in a predetermined standby period.

On the other hand, if the total degradation degree N has reached the degradation threshold Nth (N≥Nth) (YES in step 127), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step S128). Then, the degradation diagnosis process ends.

### Advantageous Effects of Third Embodiment

As described above, in the third embodiment, the diagnosis unit 22 totalizes the third degradation degree Nc in accordance with the occurrence state of the third degradation that is caused when power supplied to the field device 10 or the display device 15, determines the total degradation degree N by adding the first degradation degree Na and the third degradation degree Nc by using the predetermined ratio, and compares the total degradation degree N with the degradation threshold Nth to diagnose degradation of the display device 15.

With such a configuration, not only the first degradation due to light illuminating the display device 15 but also the third degradation due to power supply to the display device 15 can be taken into account. Consequently, the life of the display device 15 can be diagnosed more accurately.

### Fourth Embodiment

A field device 10 according to a fourth embodiment of the present disclosure will be described next.

In the first embodiment, the case where a period for which the measured illuminance L is greater than or equal to the illuminance threshold Lth is measured to totalize the first degradation degree Na has been described by way of example. In the fourth embodiment, the case where the number of times the measured illuminance L has increased to be greater than or equal to the illuminance threshold Lth from a value less than the illuminance threshold Lth will be described. Since a block diagram of the field device 10 according to the fourth embodiment is the same as that illustrated in FIG. 1, a detailed description thereof is omitted here.

The diagnosis unit 22 has a function of totalizing the first degradation degree Na of the display device 15 in accordance with the number of times the measured illuminance L calculated from the output of the photo sensor SL has increased to be greater than or equal to the illuminance threshold Lth from a value less than the illuminance threshold Lth. The diagnosis unit 22 also has a function of comparing the calculated first degradation degree Na with the degradation threshold Nth previously set for the display device 15 to diagnose degradation of the display device 15.

### Operation According to Fourth Embodiment

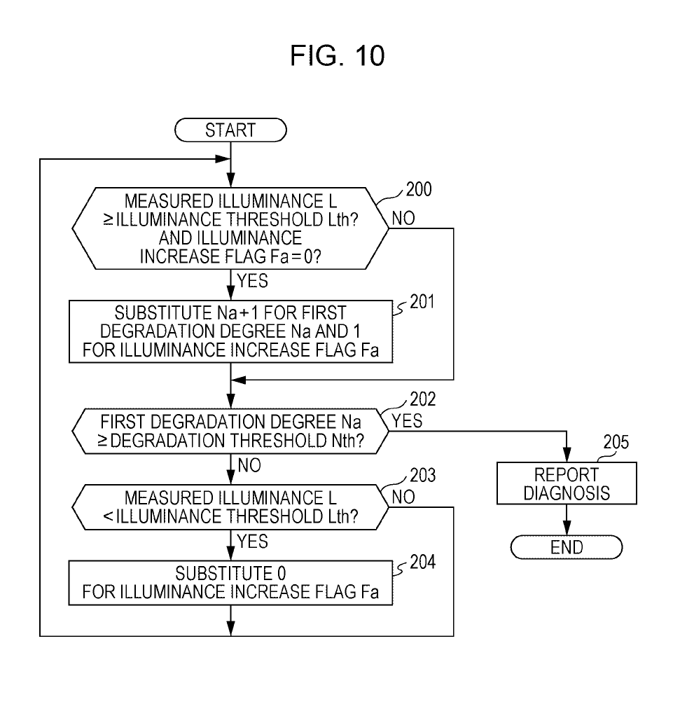

An operation of the field device 10 according to the fourth embodiment will be described next with reference to FIG. 10. FIG. 10 is a flowchart illustrating a degradation diagnosis process according to the fourth embodiment.

The CPU 20 of the field device 10 performs the degradation diagnosis process illustrated in FIG. 10 after power-on or a reset operation.

First, the occurrence-of-degradation determining unit 22A of the diagnosis unit 22 calculates the measured illuminance L from the output of the photo sensor SL acquired via the A/D conversion unit 17 and determines whether the calculated measured illuminance L is greater than or equal to the illuminance threshold Lth (L≥Lth) and whether an illuminance increase flag Fe is equal to zero (step 200). The initial value of the illuminance increase flag Fa is set to zero, which indicates that the measured illuminance L was less than the illuminance threshold Lth in the last determination.

If the measured illuminance L is greater than or equal to the illuminance threshold Lth (L Lth) and the illuminance increase flag Fa is equal to zero (YES in step 200), the degradation degree totalizing unit 22B determines that the measured illuminance L has increased to be greater than or equal to the illuminance threshold Lth from a value less than the illuminance threshold Lth and the first degradation is caused. Thus, the degradation degree totalizing unit 22B increments by 1 (+1) the first degradation degree Na that is stored in the degradation degree storage unit 14 and that is totalized after the use of the display device 15 has been started and sets the illuminance increase flag Fa to 1 (step 201).

On the other hand, if the measured illuminance L is less than the illuminance threshold Lth (L<Lth) or if the illuminance increase flag Fa is equal to 1 (NO in step 200), the degradation degree totalizing unit 22B determines that the measured illuminance L has not increased to be greater than the illuminance threshold Lth from a value less than the illuminance threshold Lth and the first degradation is not caused. Thus, the degradation degree totalizing unit 22B does not totalize the first degradation degree Na.

Then, the degradation determining unit 22C compares the first degradation degree Na stored in the degradation degree storage unit 14 with the previously set degradation threshold Nth (step 202). If the first degradation degree Na has not reached the degradation threshold Nth (Na<Nth) (NO in step 202), the occurrence-of-degradation determining unit 22A determines whether the measured illuminance L has decreased to be less than the illuminance threshold Lth (step 203).

If the measured illuminance L is less than the illuminance threshold Lth (L<Lth) (YES in step 203), the occurrence-of-degradation determining unit 22A sets the illuminance increase flag Fa to zero (step 204). The process then returns to step 200. If the measured illuminance L is greater than or equal to the illuminance threshold Lth (L≥Lth) (NO in step 203), the occurrence-of-degradation determining unit 22A does not change the value of the illuminance increase flag Fa. The process then returns to step 200. In this case, since the illuminance of light illuminating to the display device 15 does not change frequently in general, the processing of step 200 may be performed at a predetermined interval of 30 minutes or 1 hour, for example. This configuration can greatly reduce the processing load of the CPU 20.

On the other hand, if the first degradation degree Na has reached the degradation threshold Nth (Na≥Nth) (YES in step 202), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step 205). Then, the degradation diagnosis process ends.

### Advantageous Effects of Fourth Embodiment

As described above, in the fourth embodiment, since the diagnosis unit 22 totalizes the number of times the measured illuminance L has increased to be greater than or equal to the illuminance threshold Lth from a value less than the illuminance threshold Lth when totalizing the first degradation degree Na, processing such as counting of the clock may be omitted and thus the processing load of the CPU 20 can be reduced compared with the case where a period for which the first degradation is caused is measured.

### Fifth Embodiment

A field device 10 according to a fifth embodiment of the present disclosure will be described next.

In the second embodiment, the case where the period for which the measured illuminance L is greater than or equal to the illuminance threshold Lth is measured to totalize the first degradation degree Na and the period for which the measured temperature T is greater than or equal to the temperature threshold Tth is measured to totalize the second degradation degree Nb has been described by way of example. In the fifth embodiment, the case will be described where the number of times the measured illuminance L has increased to be greater than or equal to the illuminance threshold Lth from a value less than the illuminance threshold Lth is totalized as the first degradation degree Na and the number of times the measured temperature T has increased to be greater than or equal to the temperature threshold Tth from a value less than the temperature threshold Tth is totalized as the second degradation degree Nb. Since a block diagram of the field device 10 according to the fifth embodiment is the same as that illustrated in FIG. 5, a detailed description thereof is omitted here.

The diagnosis unit 22 has a function of totalizing the first degradation degree Na of the display device 15 in accordance with the number of times the measured illuminance L calculated from the output of the photo sensor SL has increased to be greater than or equal to the illuminance threshold Lth from a value less than the illuminance threshold Lth. The diagnosis unit 22 also has a function of totalizing the second degradation degree Nb of the display device 15 in accordance with the number of times the measured temperature T calculated from the output of the temperature sensor ST has increased to be greater than or equal to the temperature threshold Tth from a value less than the temperature threshold Tth. The diagnosis unit 22 further has a function of calculating the total degradation degree N by adding the calculated first degradation degree Na and the calculated second degradation degree Nb by using a predetermined ratio of Wa:Wb (where Na denotes a first weight for the first degradation degree Na and Nb denotes a second weight for the second degradation degree Nb) and of comparing the total degradation degree N with the degradation threshold Nth previously set for the display device 15 to diagnose degradation of the display device 15.

### Operation According to Fifth Embodiment

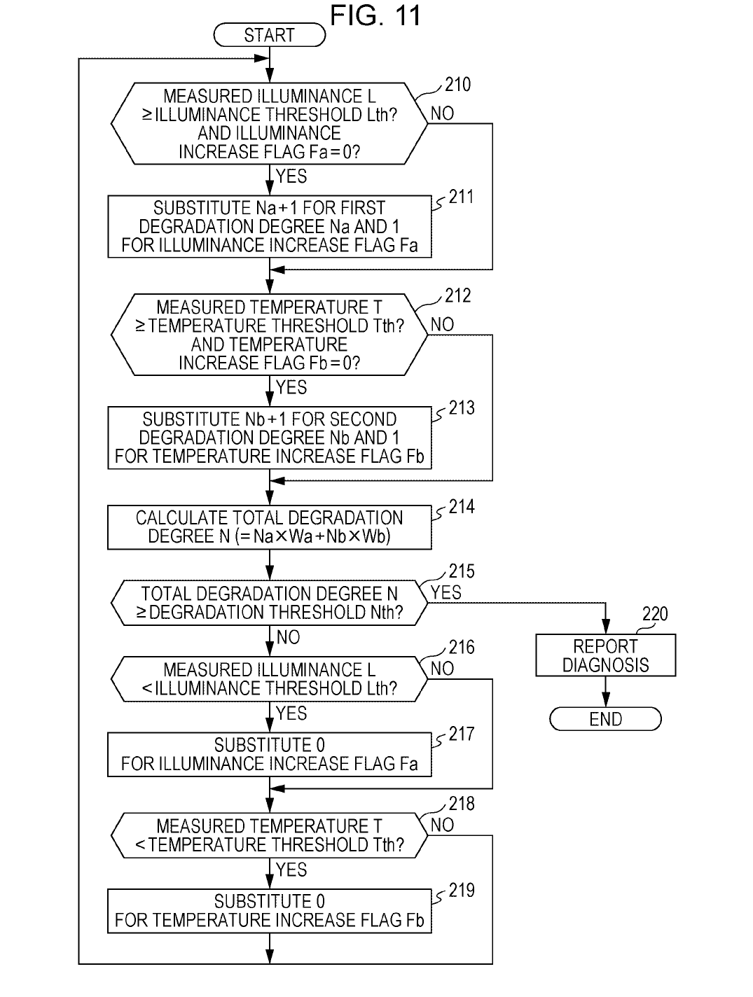

An operation of the field device 10 according to the fifth embodiment will be described next with reference to FIG. 11. FIG. 11 is a flowchart illustrating a degradation diagnosis process according to the fifth embodiment.

The CPU 20 of the field device 10 performs the degradation diagnosis process illustrated in FIG. 11 after power-on or a reset operation.

First, the occurrence-of-degradation determining unit 22A of the diagnosis unit 22 calculates the measured illuminance L from the output of the photo sensor SL acquired via the A/D conversion unit 17 and determines whether the calculated measured illuminance L is greater than or equal to the illuminance threshold Lth (L≥Lth) and whether the illuminance increase flag Fa is equal to zero (step 210). The initial value of the illuminance increase flag Fa is equal to zero, which indicates that the measured illuminance L was less than the illuminance threshold Lth in the last determination.

If the measured illuminance L is greater than or equal to the illuminance threshold Lth (L≥Lth) and the illuminance increase flag Fa is equal to zero (YES in step 210), the degradation degree totalizing unit 22B determines that the measured illuminance L has increased to be greater than or equal to the illuminance threshold Lth from a value less than the illuminance threshold Lth and the first degradation is caused, and increments by 1 (+1) the first degradation degree Na that is stored in the degradation degree storage unit 14 and that is totalized after the use of the display device 15 has been started and also sets the illuminance increase flag Fa to 1 (step 211).

On the other hand, if the measured illuminance L is less than the illuminance threshold Lth (L<Lth) or the illuminance increase flag Fa is equal to 1 (NO in step 210), the degradation degree totalizing unit 22B determines that the measured illuminance L has not increased to be greater than or equal to the illuminance threshold Lth from a value less than the illuminance threshold Lth and the first degradation is not caused, and does not totalize the first degradation degree Na.

In addition, the occurrence-of-degradation determining unit 22A calculates the measured temperature T from the output of the temperature sensor ST acquired via the A/D conversion unit 17 and determines whether the calculated measured temperature T is greater than or equal to the temperature threshold Tth (T≥Th) and whether a temperature increase flag Fb is equal to zero (step 212). The initial value of the temperature increase flag Fg is equal to zero, which indicates that the measured temperature T was less than the temperature threshold Tth in the last determination.

If the measured temperature T is greater than or equal to the temperature threshold Tth (T≥Tth) and the temperature increase flag Fb is equal to zero (YES in step 212), the degradation degree totalizing unit 22B determines that the measured temperature T has increased to be greater than or equal to the temperature threshold Tth from a value less than the temperature threshold Tth and the second degradation is caused, and increments by 1 (+1) the second degradation degree Nb that is stored in the degradation degree storage unit 14 and that is totalized after the use of the display device 15 has been started and also sets the temperature increase flag Fb to 1 (step 213).

On the other hand, if the measured temperature T is less than the temperature threshold Tth (T<Tth) or the temperature increase flag Fb is equal to 1 (NO in step 212), the degradation degree totalizing unit 22B determines that the measured temperature T has not increased to be greater than or equal to the temperature threshold Tth from a value less than the temperature threshold Tth and the second degradation is not caused, and does not totalize the second degradation degree Nb.

Then, the degradation determining unit 22C calculates the total degradation degree N (=Na×Wa+Nb×Wb) by adding the first degradation degree Na and the second degradation degree Nb stored in the degradation degree storage unit 14 by using the predetermined ratio of Wa:Wb (step 214). The degradation determining unit 22C then compares the calculated total degradation degree N with the degradation threshold Nth previously set for the display device 15 (step 215).

If the total degradation degree N has not reached the degradation threshold Nth (N<Nth) (NO in step 215), the occurrence-of-degradation determining unit 22A determines whether the measured illuminance L has decreased to be less than the illuminance threshold Lth (L<Lth) (step 216). If the measured illuminance L is less than the illuminance threshold Lth (L<Lth) (YES in step 216), the occurrence-of-degradation determining unit 22A sets the illuminance increase flag Fa to zero (step 217). The process then proceeds to step 218. If the measured illuminance L is greater than or equal to the illuminance threshold Lth (L≥Lth) (NO in step 216), the occurrence-of-degradation determining unit 22A does not change the value of the illuminance increase flag Fa. The process then proceeds to step 218.

In addition, the occurrence-of-degradation determining unit 22A determines whether the measured temperature T has decreased to be less than the temperature threshold Tth (T<Tth) (step 218). If the measured temperature T is less than the temperature threshold Tth (T<Tth) (YES in step 218), the occurrence-of-degradation determining unit 22A sets the temperature increase flag Fb to zero (step 219). The process then returns to step 210. If the measured temperature T is greater than or equal to the temperature threshold Tth (T≥Tth) (NO in step 218), the occurrence-of-degradation determining unit 22A does not change the value of the temperature increase flag Fb. The process then returns to step 210.

On the other hand, if the total degradation degree N has reached the degradation threshold Nth (N≥Nth) (YES in step 215), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step 220). Then, the degradation diagnosis process ends.

### Advantageous Effects of Fifth Embodiment

As described above, in the fifth embodiment, the diagnosis unit 22 totalizes the number of times the measured illuminance L has increased to be greater than or equal to the illuminance threshold Lth from a value less than the illuminance threshold Lth to totalize the first degradation degree Na and also totalizes the number of times the measured temperature T has increased to be greater than or equal to the temperature threshold Tth from a value less than the temperature threshold Tth to totalize the second degradation degree Nb. Thus, processing such as counting of the clock can be omitted and the processing load of the CPU 20 can be reduced, compared with the case where the periods for which the first degradation and the second degradation are caused are measured.

### Sixth Embodiment

A field device 10 according to a sixth embodiment of the present disclosure will be described next.

In the third embodiment, the case where the period for which the measured illuminance L is greater than or equal to the illuminance threshold Lth is measured to totalize the first degradation degree Na and the period for which power is supplied to the field device 10 or the display device 15 is measured to totalize the third degradation degree Nc has been described by way of example. In the sixth embodiment, the case will be described where the number of times the measured illuminance L has increased to be greater than or equal to the illuminance threshold Lth from a value less than the illuminance threshold Lth is totalized as the first degradation degree Na and the number of times power supply to the field device 10 or the display device 15 is started is totalized as the third degradation decree Nc. Since a block diagram of the field device 10 according to the sixth embodiment is the same as that illustrated in FIG. 1, a detailed description thereof is omitted here.

The diagnosis unit 22 has a function of totalizing the first degradation degree Na of the display device 15 in accordance with the number of times the measured illuminance L calculated from the output of the photo sensor SL has increased to be greater than or equal to the illuminance threshold Lth from a value less than the illuminance threshold Lth. The diagnosis unit 22 also has a function of totalizing the third degradation degree Nc of the display device 15 in accordance with the number of times power supply to the field device 10 or the display device 15 is started. The diagnosis unit 22 further has a function of calculating the total degradation degree N by adding the calculated first degradation degree Na and the calculated third degradation degree Nc by using a predetermined ratio of Wa:Wc (where Wa denotes a first weight for the first degradation degree Na and Wc denotes a third weight for the third degradation degree Nc) and of comparing the total degradation degree N with the degradation threshold Nth previously set for the display device 15 to diagnose degradation of the display device 15.

### Operation According to Sixth Embodiment

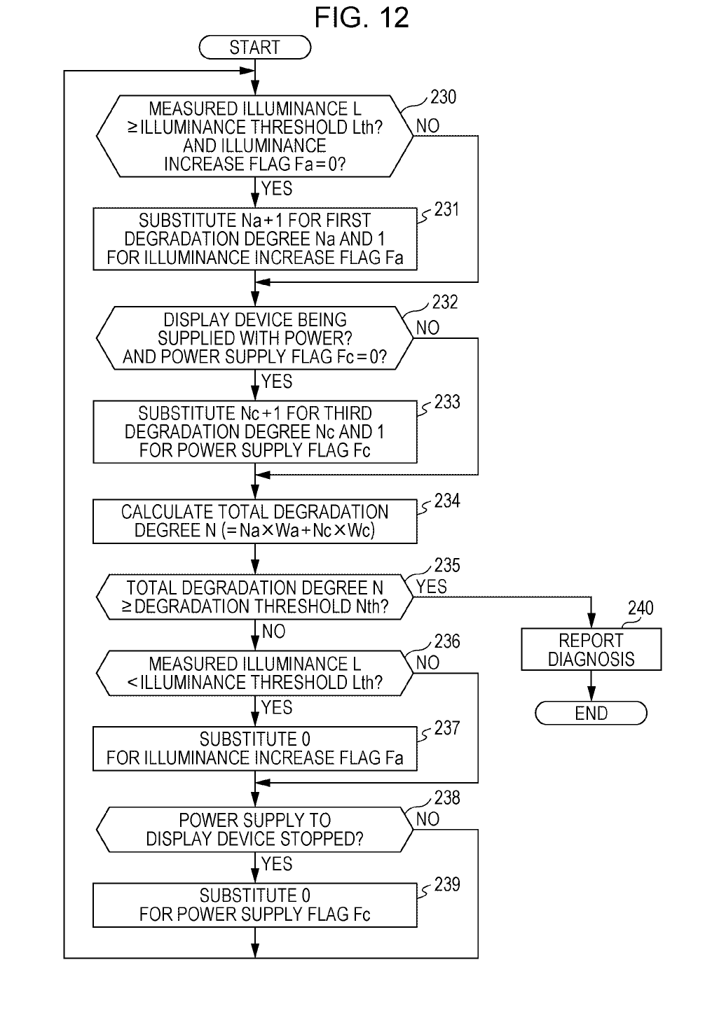

An operation of the field device 10 according to the sixth embodiment will be described next with reference to FIG. 12. FIG. 12 is a flowchart illustrating a degradation diagnosis process according to the sixth embodiment.

The CPU 20 of the field device 10 performs the degradation diagnosis process illustrated in FIG. 12 after power-on or a reset operation.

First, the occurrence-of-degradation determining unit 22A of the diagnosis unit 22 calculates the measured illuminance L from the output of the photo sensor SL acquired via the A/D conversion unit 17 and determines whether the calculated measured illuminance L is greater than or equal to the illuminance threshold Lth (L≥Lth) and whether the illuminance increase flag Fa is equal to zero (step 230). The initial value of the illuminance increase flag Fa is equal to zero, which indicates that the measured illuminance L was less than the illuminance threshold Lth in the last determination.

If the measured illuminance L is greater than or equal to the illuminance threshold Lth (L≥Lth) and the illuminance increase flag Fa is equal to zero (YES in step 230), the degradation degree totalizing unit 22B determines that the measured illuminance L has increased to be greater than or equal to the illuminance threshold Lth from a value less than the illuminance threshold Lth and the first degradation is caused, and increments by 1 (+1) the first degradation degree Na that is stored in the degradation degree storage unit 14 and that is totalized after the use of the display device 15 has been started and also sets the illuminance increase flag Fa to 1 (step 231).

On the other hand, if the measured illuminance L is less than the illuminance threshold Lth (L<Lth) or the illuminance increase flag Fa is equal to 1 (NO in step 230), the degradation degree totalizing unit 22B determines that the measured illuminance L has not increased to be greater than or equal to the illuminance threshold Lth from a value less than the illuminance threshold Lth and the first degradation is not caused, and does not totalize the first degradation degree Na.

In addition, the occurrence-of-degradation determining unit 22A determines whether power is supplied to the display device 15 on the basis of control information of the CPU 20 and whether the power supply flag Fc is equal to zero (step 232). The initial value of the power supply flag Fc is equal to zero, which indicates that power supply to the display device 15 was stopped in the last determination.

If power is supplied to the display device 15 and the power supply flag Fc is equal to zero (YES in step 232), the degradation degree totalizing unit 22B determines that power supply to the display device 15 has been started and the third degradation is caused, and increments by 1 (+1) the third degradation degree Nc that is stored in the degradation degree storage unit 14 and that is totalized after the use of the display device 15 has been started and also sets the power supply flag Fc to 1 (step 233).

On the other hand, if power is not supplied to the display device 15 or the power supply flag Fc is equal to 1 (NO in step 232), the degradation degree totalizing unit 22B determines that power supply to the display device 15 has not started and the third degradation is not caused, and does not totalize the third degradation degree Nc.

Then, the degradation determining unit 220 calculates the total degradation degree N (=Na×Wa+Nc×Wc) by adding the first degradation degree Na and the third degradation degree Nc stored in the degradation degree storage unit 14 by using the predetermined ratio of Wa:Wc (step 234). The degradation determining unit 220 compares the total degradation degree 1\T with the degradation threshold Nth previously set for the display device 15 (step 235).

If the total degradation degree N has not reached the degradation threshold Nth (N<Nth) (NO in step 235), the occurrence-of-degradation determining unit 22A determines whether the measured illuminance L has decreased to be less than the illuminance threshold Lth (L<Lth) (step 236). If the measured illuminance L is less than the illuminance threshold Lth (L<Lth) (YES in step 236), the occurrence-of-degradation determining unit 22A sets the illuminance increase flag Fa to zero (step 237). The process then proceeds to step 238. If the measured illuminance L is greater than or equal to the illuminance threshold Lth (L≥Lth) (NO in step 236), the occurrence-of-degradation determining unit 22A does not change the value of the illuminance increase flag Fa. The process then proceeds to step 238.

In addition, the occurrence-of-degradation determining unit 22A determines whether power supply to the display device 15 is stopped on the basis of the control information of the CPU 20 (step 238). If power supply to the display device 15 is stopped (YES in step 238), the occurrence-of-degradation determining unit 22A sets the power supply flag Fc to zero (step 239). The process then returns to step 230. If power supply to the display device 15 is continued (NO in step 238), the occurrence-of-degradation determining unit 22A does not change the value of the power supply flag Fc. The process then returns to step 230. At that time, since the illuminance of light illuminating to the display device 15 does not change frequently in general, the processing of step 230 may be performed at a predetermined interval of 30 minutes or 1 hour, for example, if power supply to the display device 15 is synchronized with power supply to the field device 10. This configuration can greatly reduce the processing load of the CPU 20.

On the other hand, if the total degradation degree N has reached the degradation threshold Nth (N≥Nth) (YES in step 235), the degradation reporting unit 22D displays a diagnosis regarding the degradation of the display device 15 on the display device 15 or reports the diagnosis regarding the degradation of the display device 15 to the higher-level system U from the communication I/F unit 11 via the communication channel Tx (step 240). Then, the degradation diagnosis process ends.

### Advantageous Effects of Sixth Embodiment

As described above, in the sixth embodiment, the diagnosis unit 22 totalizes the number of times the measured illuminance L has increased to be greater than or equal to the illuminance threshold Lth from a value less than the illuminance threshold Lth to totalize the first degradation degree Na. The diagnosis unit 22 also totalizes the number of times power supply to the display device 15 is started to totalize the third degradation degree Nc. Thus, processing such as counting of the clock can be omitted and the processing load of the CPU 20 can be reduced, compared with the case where the periods for which the first degradation and the third degradation are caused are measured.

### Extensions of Embodiments

Although the present disclosure has been described above with reference to the embodiments, the present disclosure is not limited to the embodiments described above. The configurations and details of the present disclosure can be modified variously within the scope as understood by a person skilled in the art. In addition, the embodiments can be carried out in any given combination within a range not causing a contradiction.

What is claimed is:

1. A field device including a display device that displays various kinds of information, the field device comprising:
a photo sensor; and
a diagnosis unit that determines a first degradation degree of the display device on the basis of a measured illuminance calculated from an output of the photo sensor and that compares the first degradation degree with a degradation threshold previously set for the display device,
wherein the diagnosis unit outputs a corresponding diagnosis when the first degradation degree reaches the degradation threshold.

2. The field device according to claim 1, wherein
the photo sensor receives light illuminating the display device, and
the diagnosis unit
compares the measured illuminance calculated from the output of the photo sensor with a previously set illuminance threshold to determine an occurrence state of first degradation caused in the display device in relation to illuminance of the light,
totalizes the first degradation degree of the display device in accordance with the determined occurrence state of the first degradation,
compares the first degradation degree with the degradation threshold to diagnose degradation of the display device, and
reports a diagnosis regarding the display device in response to the first degradation degree reaching the degradation threshold.

3. The field device according to claim 1, further comprising:
a central processing unit that controls a target installation or measures a physical quantity,
wherein the diagnosis unit is implemented by the central processing unit.

4. The field device according to claim 3, wherein the diagnosis unit totalizes the first degradation degree on the basis of a count result obtained by observing a clock of the central processing unit in a period for which the first degradation is caused.

5. The field device according to claim 2, further comprising:
a temperature sensor that detects a temperature near the display device,
wherein the diagnosis unit
compares a measured temperature calculated from an output of the temperature sensor with a previously set temperature threshold to determine an occurrence state of second degradation caused in the display device in relation to temperature,
totalizes a second degradation degree of the display device in accordance with the determined occurrence state of the second degradation,
calculates a total degradation degree by adding the first degradation degree and the second degradation degree using a predetermined ratio, and
compares the total degradation degree with the degradation threshold to diagnose degradation of the display device.

6. The field device according to claim 2, wherein
the diagnosis unit
totalizes a third degradation degree of the display device in accordance with an occurrence state of third degradation caused in the display device in relation to power supply,
calculates a total degradation degree by adding the first degradation degree and the third degradation degree using a predetermined ratio, and
compares the total degradation degree with the degradation threshold to diagnose degradation of the display device.

7. The field device according to claim 2, wherein when totalizing the first degradation degree, the diagnosis unit totalizes, as the first degradation degree, at least one of a period for which the measured illuminance is greater than or equal to the illuminance threshold and the number of times the measured illuminance increases to be greater than or equal to the illuminance threshold from a value less than the illuminance threshold.

8. The field device according to claim 5, wherein when totalizing the second degradation degree, the diagnosis unit totalizes, as the second degradation degree, at least one of a period for which the measured temperature is greater than or equal to the temperature threshold and the number of times the measured temperature increases to be greater than or equal to the temperature threshold from a value less than the temperature threshold.

9. The field device according to claim 6, wherein when totalizing the third degradation degree, the diagnosis unit totalizes, as the third degradation degree, at least one of a period for which power is supplied to the field device or the display device and the number of times power supply to the field device or the display device is started.

10. A degradation diagnosis method used in a field device including a display device that displays various kinds of information, to diagnose degradation of the display device, the degradation diagnosis method comprising:
a light-receiving step of receiving light with a photo sensor; and
a diagnosis step, performed with a diagnosis unit, of determining a first degradation degree of the display device on the basis of a measured illuminance calculated from an output of the photo sensor, of comparing the first degradation degree with a degradation threshold previously set for the display device, and of outputting a corresponding diagnosis when the first degradation degree reaches the degradation threshold.
